(19) United States
(12) Patent Application Publication
(10) Pub. No.: US 2017/0120551 A1
(43) Pub. Date: May 4, 2017

(54) DEVICE AND METHOD FOR CONTROLLING THE PRIMARY DRIVE OF A FINE BLANKING PRESS

(71) Applicant: Feintool International Holding AG, Lyss (CH)

(72) Inventors: Hans-Ruedi HONEGGER, Wolfhausen (CH); Andreas WALTHER, Laupen (CH); Alex WEHRLI, Kehrsatz (CH)

(21) Appl. No.: 15/203,463

(22) Filed: Jul. 6, 2016

(30) Foreign Application Priority Data
Jul. 6, 2015 (EP) 15002015.4

(51) Int. Cl. B30B 15/16; B21D 22/02

(52) U.S. Cl. CPC B30B 15/161; B21D 22/02; B30B 15/163

(57) ABSTRACT

In an apparatus and a method for controlling the primary drive of a hydraulically driven fine blanking press, the hydraulic circuit is simplified due to the elimination of hydraulic tubes, and the amount of hydraulic fluid is reduced, while increasing the number of strokes and achieving a simple design for the press.

### BACKGROUND OF THE INVENTION

The invention relates to a device for controlling the primary drive of a hydraulically driven fine blanking press, comprising a main cylinder, which is disposed in the base and in which the main piston/ram is guided, which can be acted on by hydraulic fluid via pressure chambers, carries out a stroke movement between BDC and TDC in the direction of the stroke axis and supports a table, further comprising double-acting fast stroke pistons, which are guided in fast stroke cylinders, can be acted on by hydraulic fluid via pressure chambers, and include piston rods for the rapid approach/probe stroke of the main piston and the table plate, and a hydraulic system, which includes at least one hydraulic pump unit, for supplying the pressure chambers with the hydraulic fluid that is set by a central control unit to a predefined working pressure.

The invention further relates to a method for controlling the primary drive of a hydraulically driven fine blanking press, comprising a main piston, which is guided in a main cylinder of the base, supports a table, and carries out a stroke movement between the lower dead point UT and and the upper dead point OT, in which the main piston, together with the table, is displaced in the rapid approach/probe stroke between UT and OT, or OT and UT, by pressurization of the pressure chambers of a fast stroke piston disposed in the fast stroke cylinder, the rapid motion/probe stroke is then ended, and subsequently the main piston, during the power stroke, carries out the blanking or forming operation, wherein the pressure chambers of the main piston are acted on by a working pressure of a hydraulic fluid from a hydraulic system which is predefined by a central control unit and generated by a hydraulic pump unit.

The fine blanking process requires specific triple-action presses, which essentially operate from the bottom to the top and enable a controlled regulation of the blanking operation, including the auxiliary functions for the vee ring, pressure pad and ejector. The vee ring force and the counter force are generated hydraulically, and the blanking force is generated mechanically or hydraulically.

A number of piston arrangements exist, which are used in presses for driving or pressurization purposes. The prior art according to DE 2 218 476 A1 and DE 2 264 429 A1 relates to a fine blanking press comprising two rigidly connected frame parts, on which two table bodies are arranged, which are used to clamp on two tool parts and which can be displaced by hydraulic means axially toward and away from each other. A cylindrical chamber is provided in the first frame part and receives therein two pistons movable coaxially relative to each other, with the first piston being connected to a piston rod and the second surrounding this piston rod and forming part of the first table body arranged displaceably on the first frame part. The second piston has a female thread and is screwed to a bushing having a male thread, so that the axial position of the second piston can be set.

From DE 195 24 042, a method for regulating the drive is known, in particular for a hydraulic press for forming and/or cutting metal sheets, comprising at least one double-acting piston-cylinder unit for driving a press ram. This press operates in the direction of gravity, which is to say from top to bottom. During a first working phase of the press, the top and bottom cylinder chambers of the piston-cylinder unit are connected via a valve system during the downward motion of the unloaded press ram. A motor/pump system comprising a volume-controlled hydraulic motor/pump system is provided for the subsequent forming phase, the system being driven at least via a chargeable accumulator system, and the regulatable torque can be supplied to a regulatable pump system.

DE 198 22 436 A1 describes a method for operating a hydraulic press, in which the force required for deforming a workpiece is created by the piston of a double-acting cylinder, and this force is transmitted via mechanical intermediate members from the piston to a press tool, wherein the press tool impinges on the workpiece only after the press tool has traversed a first length of travel, and forming then takes place while a second length of travel is being traversed. The press operates from top to bottom, and the rapid approach is essentially caused by the inherent weight of the press crosshead when the pressure is relieved.

DE 10 2012 006 981 A1 discloses a hydraulic press comprising a ram, which can be adjusted by way of a hydraulic drive device, wherein the hydraulic drive device comprises a working cylinder in which a drive piston is displaceably received, which divides the interior of the drive cylinder into a first working chamber and a second working chamber, which can be acted on by a hydraulic fluid. At least one hydraulic return device is provided so as to bring the ram into the starting position thereof after the forming process.

The basic idea of this known prior art is to discharge the hydraulic fluid during the forming process from the second working chamber via a pump into the storage tank.

Providing rapid approach cylinders during the advance stroke of the press ram are known from a number of solutions (DE 196 43 635 A1, DE 197 41 879 A1, DE 198 22 436 A1, DE 102 15 003 A1, DE 10 2004 006 126 B4, DE 10 2009 058 407 A1, EP 0 311 779 B1, EP 0 615 837 B1, EP 891 235 B1.)

In all these known solutions, the main piston and the rapid approach piston belong to separate hydraulic circuits, in which the hydraulic fluid displaced from the working chambers is either discharged during the downward motion of the pistons into a tank ((DE 10 2009 058 407A1), or shifted from the top working chamber into the bottom working chamber (DE 10 2004 006 126 B4, DE 196 42 635 A1, DE 102 15 003 A1, EP 0 891 235 B1).

This shifting is carried out in separately routed hydraulic tubes, and independently of the position of the fast stroke piston in the fast stroke cylinder. The fast stroke cylinders are generally disposed on the head piece of the press and must therefore be able to support the entire top structure of the press, including the traverse member, and lift it during the advance stroke. The primary drive/ram of these known presses is not equipped with a rapid approach function or fast stroke cylinder, so that the cycle time or the achievable number of strokes is accordingly low.

### SUMMARY OF THE INVENTION

With this prior art, it is the object of the invention to create a device and a method for controlling the primary drive of a hydraulically driven fine blanking press, the hydraulic circuit of which is simplified due to the elimination of hydraulic tubes, and with which the amount of hydraulic fluid can be reduced, while increasing the number of strokes and achieving a simple design for the press.

The solution according to the invention is based on the finding of displacing the hydraulic fluid that is present in the pressure chambers of the main piston during the rapid approach/probe stroke from one pressure chamber into the other pressure chamber of the main piston during the advance in the stroke direction of the fast stroke pistons.

This is achieved in that the main piston comprises disk-like protruding working surfaces, which in the main cylinder chamber are located on top of one another, partitioning the first (top) and second (bottom) pressure chambers with a low stroke, with which first (top) fluid channels and second (bottom) fluid channels are associated in the base, which are connected to the hydraulic system, wherein the first fluid channels are connected to the second fluid channels by a respective bypass channel disposed in the base, the bypass channel together with these channels and the pressure chambers forming an inner hydraulic system, which during the rapid approach is opened by pressure-controlled proportional valves during displacement of the hydraulic fluid from the first pressure chamber into the second pressure chamber, and closed during the power stroke, and in that, during the power stroke, at least one second fluid channel is a power stroke channel, the first pressure chamber is connected to a vent channel, wherein this fluid channel is connected to a supply channel and branch channel for supplying hydraulic fluid having a predefined pressure into the second pressure chamber, and the vent channel is connected to a collection tank for discharging the hydraulic fluid that is displaced from the first pressure chamber via a tank valve.

According to a further preferred embodiment of the device according to the invention, it is provided that, during the power stroke, the second pressure chamber of the main piston is connected to the hydraulic pump unit via a safety valve, at least one pressure pick-up for pressure detection, at least one pressure control valve for limiting the pressure of the delivery flow, and a proportional valve for setting the delivery volume.

In a further preferred embodiment of the device according to the invention, the main piston can have identical or differently sized working surfaces, whereby both constant velocity pistons and other pistons can be used, depending on the application.

It is also advantageous when the proportional valves and the tank valve are pressure-controlled built-in valves.

A further preferred embodiment of the device according to the invention provides for the fast stroke piston to partition pressure chambers having differently sized effective surfaces in the fast stroke cylinder, which are connected via channels provided in the base to the hydraulic system, wherein the pressure chamber having the larger effective surface is integrated into a hydraulic branch composed of a double check valve, a 4/3-way proportional valve, a controllable proportional valve, and a high pressure accumulator, and the pressure chamber having the smaller effective surface is connected via the 4/3-way proportional valve to the collection tank.

The differently sized effective surfaces on the fast stroke piston make it possible to carry out the rapid approach in the upward and downward directions at differing speeds.

Advantageously, the larger effective surface of the fast stroke piston is associated with the upward motion.

It has proven advantageous to accommodate two opposing fast stroke cylinders oriented parallel to the stroke axis in the base, the piston rods of the cylinders being connected to a respective carrier, which are each attached to one side of the table.

On the upper face of the base, the fast stroke cylinders are closed in a pressure-tight manner by a respective cover, so that easy installation and accessibility are ensured.

It is also advantageous that a displacement measuring unit for detecting the TDC position of the main piston is associated with the main piston, and the tank valve for building a counter force for reducing the cutting impact is associated with the first pressure chamber of the main piston.

According to a preferred embodiment of the invention, the hydraulic pump unit comprises at least one proportional valve for setting the delivery volume, at least one pressure pick-up for activating the proportional valve, and at least one pressure control valve for limiting the pressure and maintaining the delivery flow.

The object of the invention is further achieved by a method in which the pressure chambers of the fast stroke piston during the rapid approach/probe stroke are fed from a high pressure accumulator that is permanently set to the working pressure, and at the same time, the pressure chambers of the main piston are separated from the hydraulic system and connected via fluid channels and bypass channels, so that the hydraulic fluid is displaced from the first pressure chamber into the second pressure chamber in a substantially depressurized state in the stroke direction of the fast stroke piston during the rapid approach.

It is of essential significance for the control of the pressure chambers of the fast stroke piston that the working pressure in the pressure chamber of the fast stroke piston having the larger effective surface is set by the central control unit via a double check valve, a 4/3-way proportional valve, a controllable proportional valve, and a high pressure accumulator, and the working pressure in the pressure chamber of the fast stroke piston having the smaller effective surface is set via the 4/3-way proportional valve.

In a further embodiment of the method according to the invention, during the power stroke, the working pressure in the bottom pressure chamber of the main piston is set by the central control unit via an activatable proportional valve, at least one pressure pick-up for pressure detection, at least one pressure control valve for limiting the pressure of the delivery flow, and a proportional valve for the delivery volume and the hydraulic pump unit, and the working pressure in the first pressure chamber is set via the proportional valve.

It is particularly advantageous that the OT position of the main piston is set by the central control unit via a displacement measuring system, wherein the delivery volume of the hydraulic pump unit is reduced before OT is reached, or a counter pressure is generated by the tank valve in the first pressure chamber.

Further advantages and details will be apparent from the following description with reference to the accompanying drawings.

The invention will be described in more detail hereafter based on one embodiment.

In the drawings:

### BRIEF DESCRIPTION OF THE DRAWINGS

FIG. 1 shows a perspective view of a fine blanking press connected to the hydraulic system;

FIG. 2 shows a perspective view of the base together with the table;

FIG. 3 shows a section of the base together with the table along line III-Ill from FIG. 2;

FIGS. 4a and 4b each show a perspective view of the base, with an illustration of the locations of the fluid channels and of the vent channel;

FIG. 5 shows a section of the base together with the table along line V-V from FIG. 2;

FIG. 6 shows a section of the base together with the table along line VI-VI from FIG. 2;

FIGS. 7a and 7b show schematic representations of the displacement of the hydraulic fluid from one pressure chamber into the other pressure chamber of the main piston as a function of the stroke position of the fast stroke piston; and

FIG. 8 shows a schematic representation of the flow of the method according to the invention.

### DETAILED DESCRIPTION OF THE INVENTION

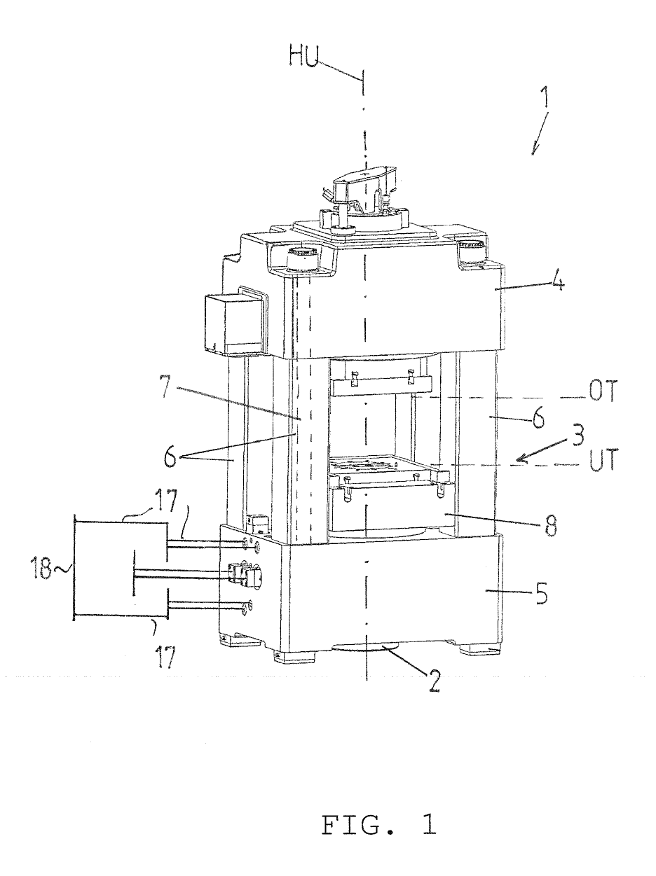

FIG. 1 shows a perspective representation of a hydraulically driven fine blanking press 1, the main piston 2 of which essentially carries out a stroke movement between a lower dead point and an upper dead point OT in the direction of the stroke axis HU from the bottom to the top. The body 3 of the press 1 comprises a head piece 4, a base 5, box-shaped hollow pillars 6, and tie rods 7.

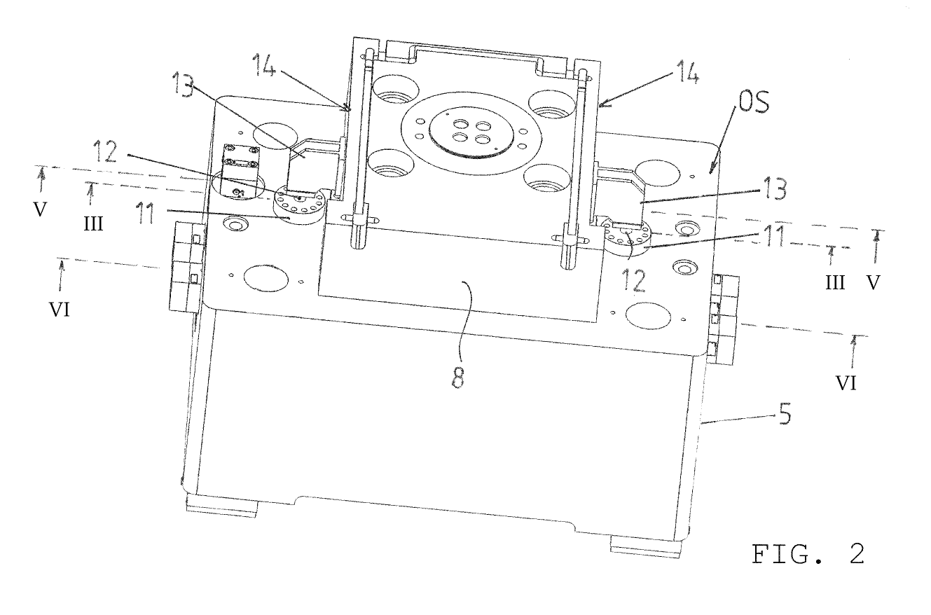

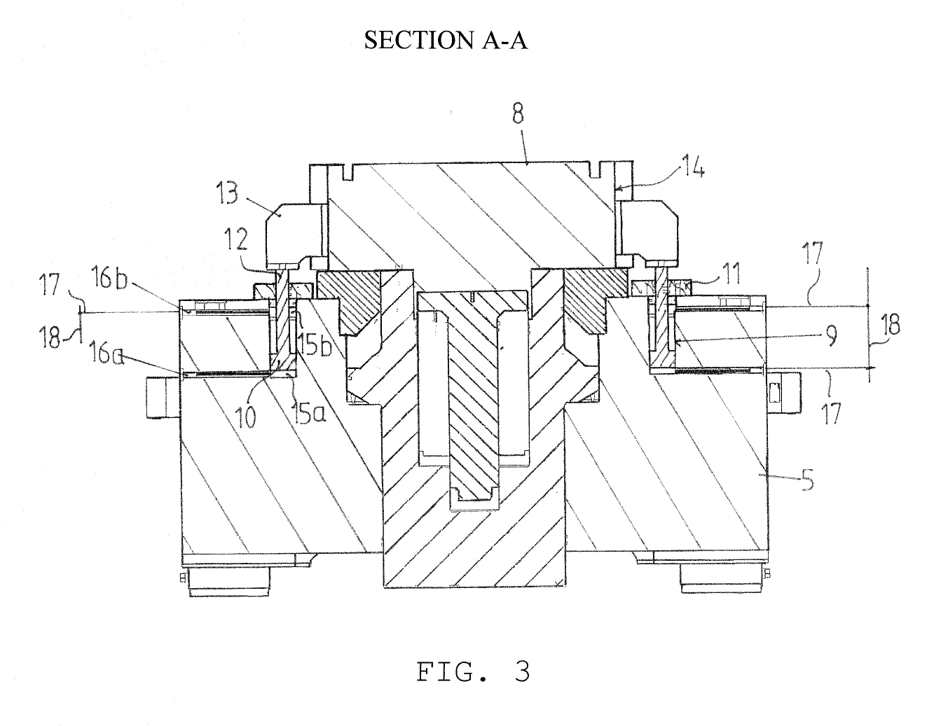

As is illustrated in FIGS. 2 and 3, a table 8, which supports the bottom tool part (not shown in more detail), is disposed on the upper face OS of the base 5.

Approximately centrally, two opposing fast stroke cylinders 9 oriented parallel to the stroke axis HU are introduced into the base 5, which each receive a double-acting fast stroke piston 10 and are closed by a cover 11. The fast stroke piston 10 includes a piston rod 12, which extends through the cover 11 and is connected to a carrier 13, which is attached to a side wall 14 of the table 8. The fast stroke piston 10 partitions a first and a second pressure chamber 15a and 15b (see also FIG. 3) in the fast stroke cylinder 9. The pressure chamber 15a and the pressure chamber 15b are connected via a channel 16a and 16b, respectively, which are introduced in the base 5, to the hydraulic tube 17 of the hydraulic system 18 so as to be acted upon by hydraulic fluid having a predefined pressure, such that it is possible to vertically displace the table 8 during the rapid approach in the direction of the head piece 4.

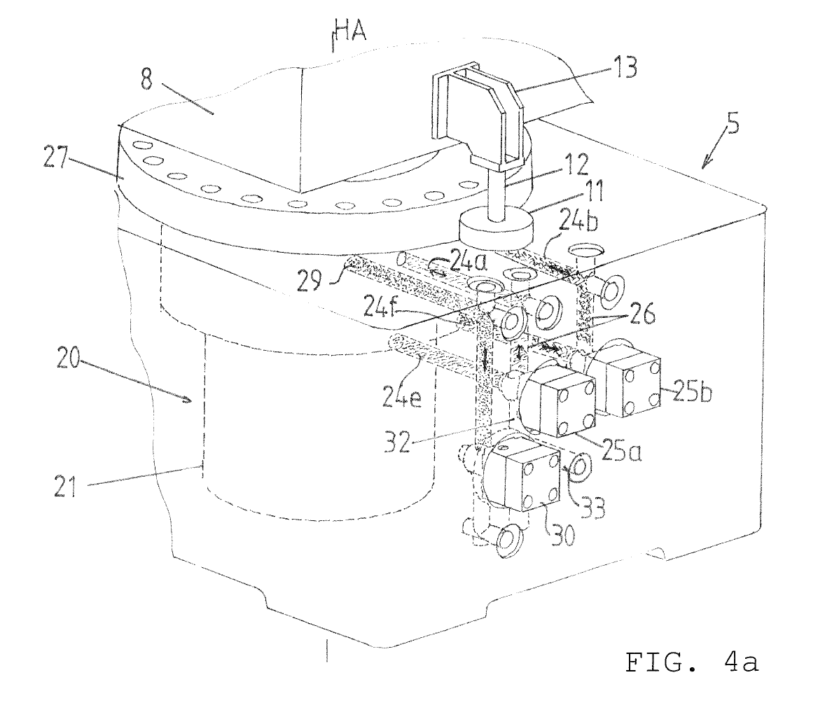

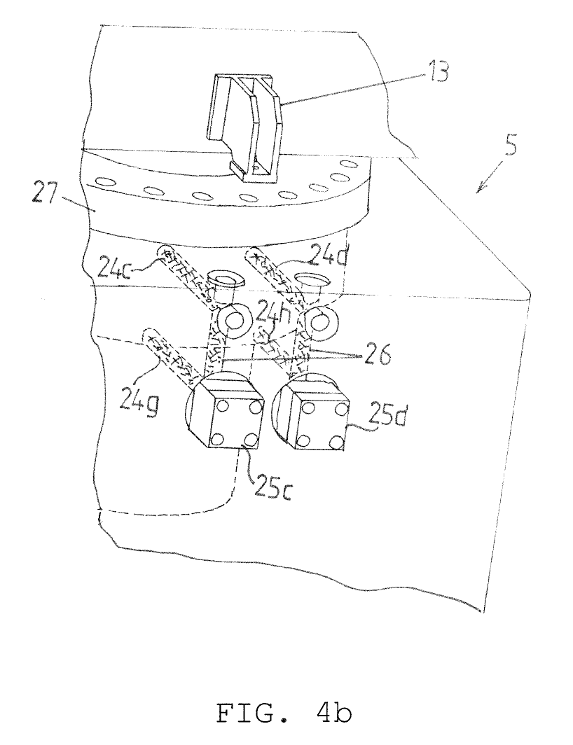

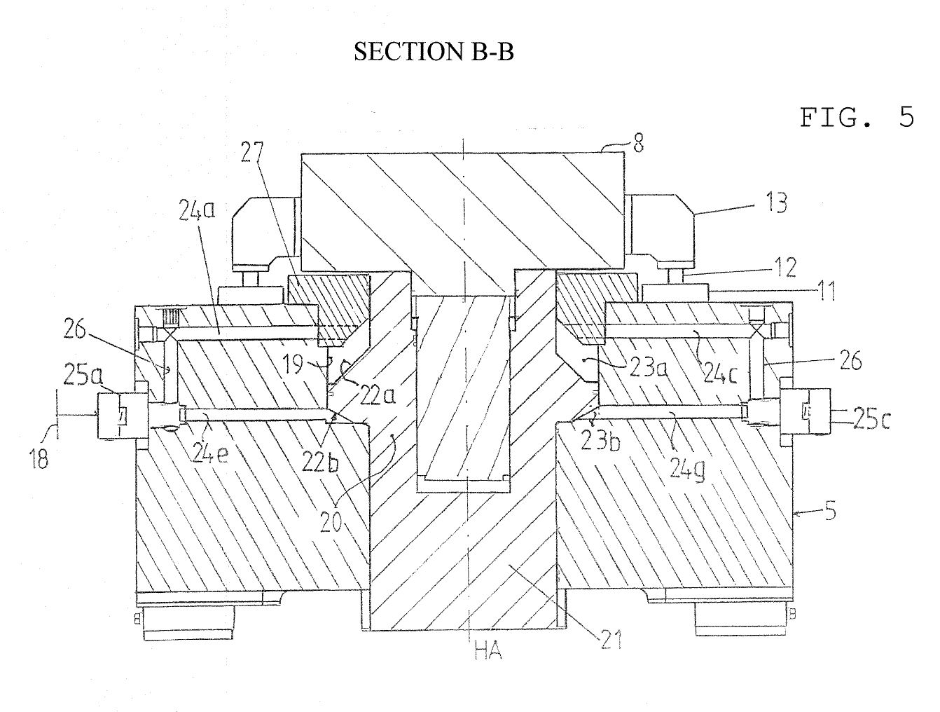

FIGS. 4a, 4b and 5 show the spatial locations of the fluid channels 24a to 24h and of the vent channel 29 in the base 5 in a transparent representation and in a section along line V-V from FIG. 2.

A main cylinder chamber 19 is formed in the base 5, the axis HA of which is located on the stroke axis HU of the fine blanking press and receives the double-acting main piston 20. The main piston 20 has a cylindrical shaft 21, which comprises disk-like working surfaces 22a and 22b protruding perpendicularly to the axis HA, which partition the main cylinder chamber 19 into a first (top) pressure chamber 23a and a second (bottom) pressure chamber 23b having a low stroke height, so that the base 5 is compact and has a low height.

The main cylinder chamber 19, and thus the pressure chamber 23a, is closed in a pressure-tight manner by a cover 27, which is attached to the base 5.

The first (top) fluid channels 24a, 24b, 24c and 24d and the second (bottom) fluid channels 24e, 24f, 24g and 24h, which are located in the base 5 on top of one another perpendicularly to the stroke axis HU corresponding to the heights of the pressure chambers 23a and 23b, lead into the pressure chambers 23a and 23b of the main piston 20. The fluid channels 24a to 24d are connected to the fluid channels 24e to 24h by a respective bypass channel 26.

Furthermore, a pressure-controlled proportional valve 25a, 25b, 25c and 25d is inserted as a built-in valve into each of the second (bottom) fluid channels 24e to 24h, the valve closing the respective bypass channel 26 when the second pressure chamber 23b is acted upon by hydraulic fluid having a predefined pressure from the hydraulic system 18.

During the rapid approach, the main piston 20 carries out a corresponding stroke movement between lower dead point UT and upper dead point OT and, when the proportional valve 25a to 25d is open, displaces the hydraulic fluid present in the first (top) pressure chamber 23a via the first (top) fluid channels 24a to 24d, the bypass channels 26, and the second (bottom) fluid channels 24e to 24h into the second (bottom) pressure chamber 23b. The first (top) pressure chamber 23a, the first (bottom) fluid channels 24a to 24d, the bypass channels 26, the bottom fluid channels 24e to 24h, and the second (bottom) pressure chamber 24b thus form a closed hydraulic system, which can be opened or closed, depending on the position of the proportional valves 25a to 25d, so that the first (top) pressure chamber 23a and the second (bottom) pressure chamber 23b are substantially depressurized, and the hydraulic fluid is displaced into the second (bottom) pressure chamber 23b of the main piston 20, and a fluid column can be created in the movement direction BR of the fast stroke piston 10 during the rapid approach.

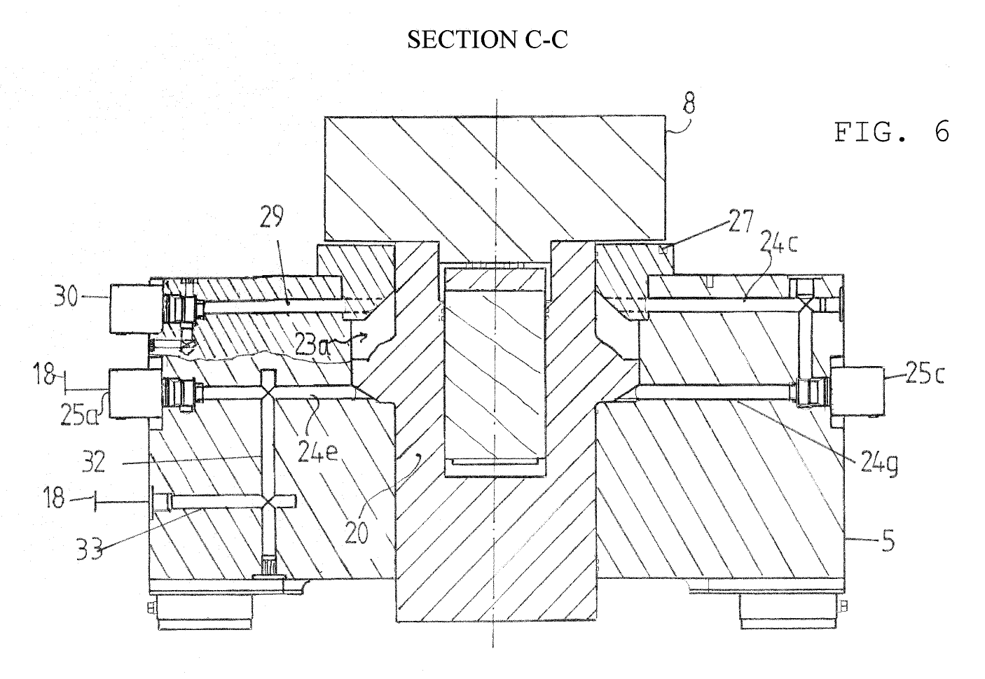

When the fast stroke piston reaches the target position thereof during the rapid approach, the proportional valves 25a to 25d switch into the closed position, and the power stroke begins, which is described in more detail hereafter based on FIG. 6.

FIG. 6 shows the base 5 in a further section along line VI-VI from FIG. 2, which illustrates the locations of the fluid channel 24e and of the vent channel 29 (see also FIG. 4a).

The vent channel 29 opens into the first pressure chamber 23a of the main piston 20, and the fluid channel 24e opens into the second pressure chamber 23b, which are disposed on top of one another perpendicular to the stroke axis HU corresponding to the heights of the pressure chambers 23a and 23b.

A tank valve 30 for opening and closing the vent channel 29 is inserted into the vent channel 29 as a built-in valve, which is in the open position when, during the power stroke, the hydraulic fluid present in the pressure chamber 23a is displaced into the collection tank 44.

The fluid channel 24e is connected to a supply channel 32, which is situated parallel to the stroke axis HU in the base 5, and to a branch channel 33, which branches off this supply channel and via which the hydraulic system 18, which is not shown in detail, is connected.

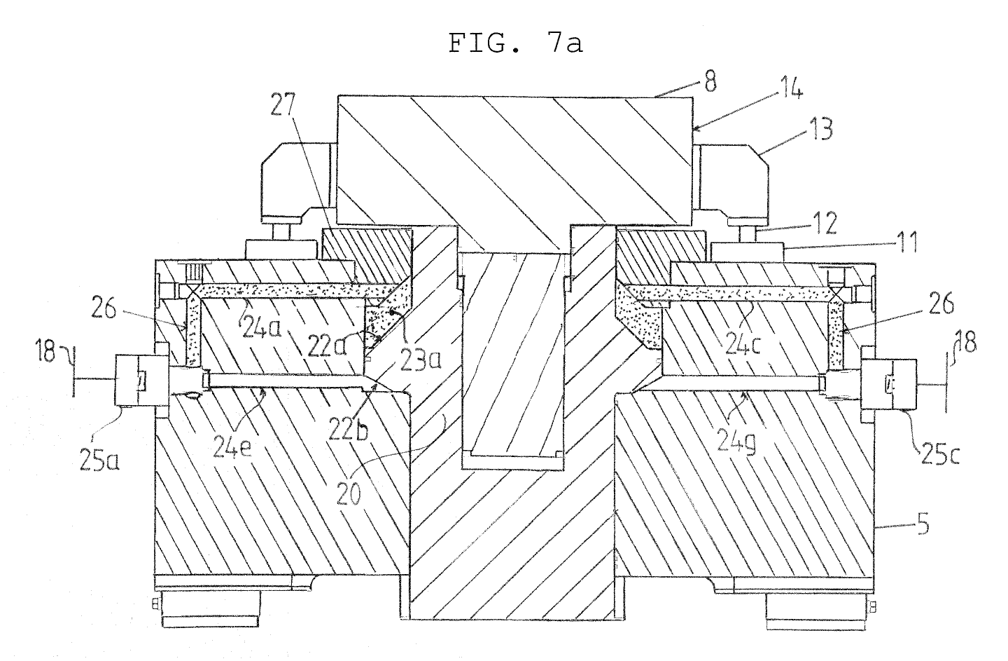

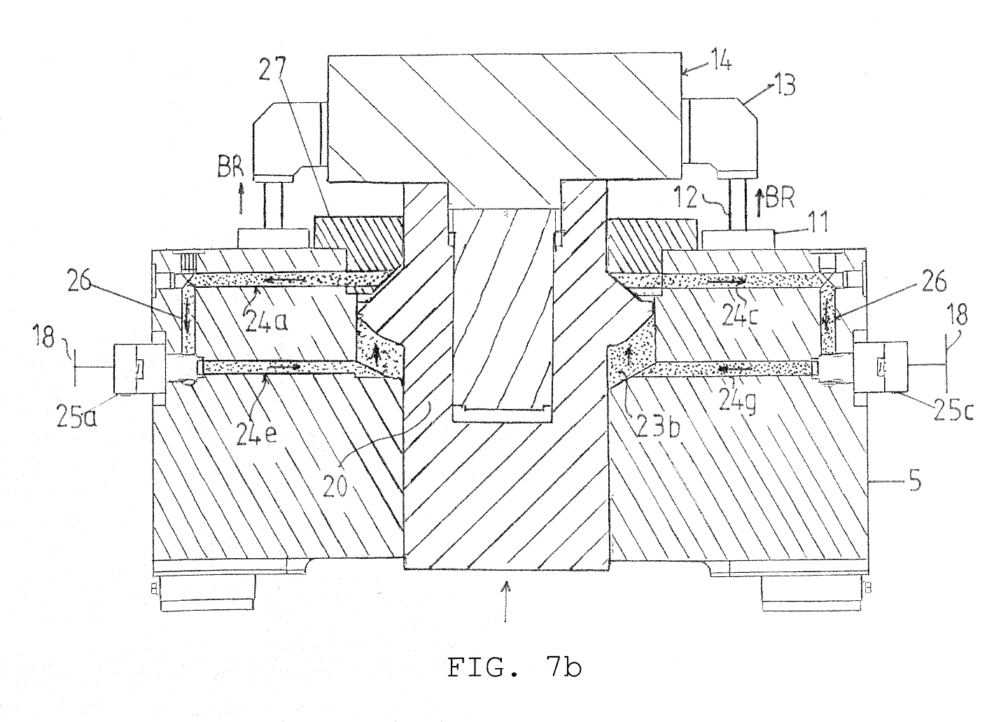

FIGS. 7a and 7b schematically show the displacement of the hydraulic fluid from the first (top) pressure chamber 23a into the second (bottom) pressure chamber 23b during the stroke movement of the main piston 20 in the direction of TDC during the rapid approach, based on the example of fluid channels 24a and 24b.

The main piston 20, together with the table 8, carries out a stroke in the direction of OT due to the fast stroke piston 10. As a result of the upward motion of the working surface 22a of the main piston 20, the hydraulic fluid present in the first (top) pressure chamber 23a is displaced from the first (top) pressure chamber 23a when the tank valve 30 is closed, and when the proportional valve 25a is open, the fluid reaches the bottom pressure chamber 23b via the first fluid channel 24a, the bypass channel 26, and the second fluid channel 24e. The displacement is indicated in FIG. 7b by an arrow. In FIG. 7b, the fast stroke piston 10 has reached the top target position thereof, the proportional valve 25a closes, the proportional valve 30 opens, and the power stroke begins.

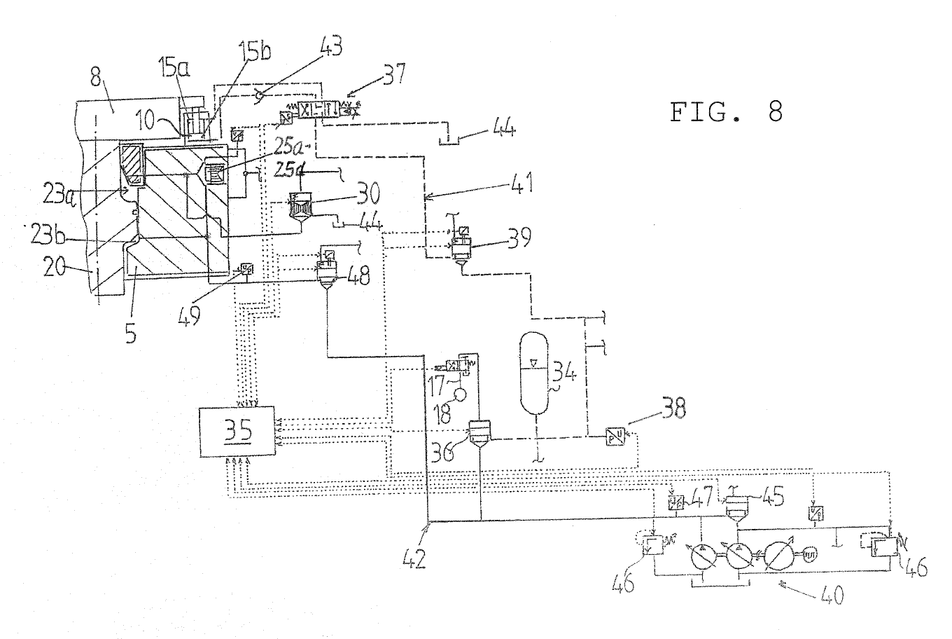

The flow of the method according to the invention will be described based on FIG. 8, which shows the hydraulic branch 41 for the rapid approach and the hydraulic branch 42 for the power stroke of the main piston 20.

The hydraulic branch 41 includes a high pressure accumulator 34 for hydraulic fluid, a logic proportional valve 36, which is activated by the central control unit 35 and which is connected to the hydraulic system 18 via the hydraulic tube 17 and sets the pressure level in the high pressure accumulator 34, a pressure pick-up 38, a safety valve 39, a 4/3-way proportional valve 37, which activates or deactivates the supply of the hydraulic fluid to the pressure chambers 15a or 15b depending on the position of the fast stroke piston 10 in the fast stroke cylinder 9, a double check valve 43 associated with the bottom pressure chamber 15b, and the pressure chambers 15a and 15b of the fast stroke pistons 10.

The pressure chambers 15a and 15b of the fast stroke piston 10 are supplied via the shared high pressure accumulator 34 with hydraulic fluid having an appropriate pressure, which is set by appropriate activation of the valve 36 by the central control unit 35 as an accumulator charge.

As soon as the fast stroke piston has reached the top target position thereof during the rapid approach, the proportional valve 25a installed in the fluid channel 24e closes, the tank valve 30 opens, and the 4/3-way proportional valve 37 switches to a center position.

The fluid channel 24e then assumes the function of a power stroke channel, in which hydraulic fluid having a predefined pressure is supplied to the second pressure chamber 23b.

The hydraulic branch 42 for the power stroke comprises a hydraulic pump unit 40, with which at least one proportional valve 45 for setting the delivery volume, at least one pressure control valve 46 for limiting the pressure of the delivery flow, and at least one pressure pick-up 47 for pressure detection for limiting the power and forwarding the pressure value to the central control unit 35 for activation of the pressure control valve 46 are associated, a safety valve 48, which activates or deactivates the supply of hydraulic fluid conducted to the bottom pressure chamber 23b, a pressure pick-up 49 for ascertaining the pressure value, which is forwarded to the central control unit for activation of the pressure control valve 46, and the pressure chambers 23a and 23b of the main piston 20.

Once the main piston 20 has reached the upper dead point OT thereof, the power stroke is ended. The safety valve 48 for the power stroke and the tank valve 30 close, at the same time the proportional valve 25a for the fluid channel 24e and the proportional valve 37 for supplying hydraulic fluid from the high pressure accumulator 34 open, and the rapid approach starts, in which the top pressure chamber 15a of the fast stroke piston 10 is acted upon by hydraulic fluid having a predefined pressure, so that the main piston 20, together with the table 8, is lowered, and reaches the bottom target position thereof. The 4/3-way proportional valve 37 switches, so that the bottom pressure chamber 15b can be acted upon by hydraulic fluid, and the fast stroke piston 10 is moved in the direction of the top target position thereof.

As soon as the fast stroke piston has reached the top target position thereof, another power stroke starts.

1. A apparatus for controlling the primary drive of a hydraulically driven fine blanking press, comprising a main cylinder chamber, which is disposed in a base and in which a main piston guided, pressure chambers, for the main piston configured to act upon the piston with hydraulic fluid so that the piston carries out a stroke movement between a lower dead point UT and and an upper dead point OT, a table supported by the main piston, double-acting fast stroke pistons which are guided in fast stroke cylinders and include piston rods, pressure chambers for the fast stroke pistons configured to act upon the pistons with hydraulic fluid, the piston rods being configured to engage the table for the rapid approach stroke of the main piston and the table, and a hydraulic system, which includes at least one hydraulic pump unit, configured to supply the pressure chambers with hydraulic fluid that is set by a central control unit to a predetermined working pressure, wherein the main piston comprises disk shaped protruding working surfaces partitioning the main cylinder chamber into a first pressure chamber above second pressure chambers fluid channels and second fluid channels in the base opening into the first and second pressure chamber respectively and being connected to the hydraulic system, bypass channels in the base connecting the first fluid channels to the second fluid channels, the bypass channels together with the first and second fluid channels and the first and second pressure chambers comprising the hydraulic system, by pressure-controlled proportional valves, the central control unit being configured to open the proportional valves during rapid approach of the table to the OT during which displacement of the hydraulic fluid from the first into the second pressure chamber occurs, to close the proportional valves during the power stroke so that, during the power stroke, at least one of the second fluid channels is a power stroke channel and the first pressure chamber is connected to a vent channel, the power stroke channel being connected to a supply channel and a branch channel for supplying hydraulic fluid having a predetermined pressure into the second pressure chamber, and the vent channel is connected to a collection tank for discharging the hydraulic fluid that is displaced from the first pressure chamber via a tank valve.

2. The apparatus according to claim 1, wherein the central control unit is configured that, during the power stroke, the second pressure chamber is connected to the hydraulic pump unit via a safety valve, at least one pressure pick-up for pressure detection of delivery flow of the hydraulic fluid, at least one pressure control valve for limiting the pressure of the delivery flow, and a proportional valve for setting the delivery volume.

3. (canceled)

4. The apparatus according to claim 1, wherein the proportional valves and the tank valve (30) are pressure-controlled built-in valves.

5. The apparatus according to claim 1, wherein the fast stroke piston partitions each of the fast stroke cylinders into pressure chambers having differently sized working surfaces in the fast stroke cylinder, channels provided in the base connect the fast stroke cylinder pressure chamber to the hydraulic system, wherein the pressure chamber having the larger effective surface is integrated into a hydraulic branch comprised of a double check valve, a 4/3-way proportional valve, a safety valve, and a high pressure accumulator, and the pressure chamber having the smaller effective surface is connected via the 4/3-way proportional valve to the collection tank.

6. The apparatus according to claim 1, further comprising, in the base at opposite sides of the table, two opposing fast stroke cylinders oriented parallel to a stroke axis of the pistons, the piston rods of the cylinders being connected to carriers, which are each attached to a respective side wall of the table.

7. The apparatus according to claim 6, wherein each of the fast stroke cylinder cylinders is closed in a pressure-tight manner by a cover, through which a respective of the piston rods extend.

8. The apparatus according to claim 1, wherein the hydraulic pump unit comprises a proportional valve configured to set the delivery volume, a pressure pick-up configured to activate the delivery volume setting proportional valve, and a pressure control valve for limiting pressure of the delivery flow.

9. The device according to claim 1, further comprising a displacement measuring unit configured to detect the OT position of the main piston.

10. A method for controlling the primary drive of a hydraulically driven fine blanking press with the apparatus of claim 1, in displacing the main piston, together with the table, during the rapid approach stroke between UT and OT, or OT and UT, by pressurizing the pressure chambers of a the fast stroke pistons, then, in a power stroke subsequent to the rapid stroke carrying out a blanking or shaping operation, by applying working pressure of a hydraulic fluid to the pressure chambers of the main piston, from the hydraulic system generated by the hydraulic pump unit and controlled by the control unit, wherein, during the rapid approach stroke, feeding the pressure chambers of the fast stroke piston a high pressure accumulator that is permanently set to the working pressure, and at the same time, disconnecting the pressure chambers of the main piston from the hydraulic system and connecting the pressure chambers of the main cylinder to each other via fluid channels and bypass channels (26) so as to displace the hydraulic fluid from the first pressure chamber into the second pressure chamber in a substantially depressurized state during the rapid approach stroke of the fast stroke piston.

11. The method according to claim 10, further comprising setting the working pressure in the pressure chamber of the fast stroke piston having the larger effective surface with the central control unit via a double check valve, a 4/3-way proportional valve, a controllable proportional valve, and a high pressure accumulator, and setting the working pressure in the pressure chamber of the fast stroke piston having the smaller effective surface is set via the 4/3-way proportional valve.

12. The method according to claim 10, further comprising, during the power stroke, setting the working pressure in the second pressure chamber of the main piston is set with the central control unit via a safety valve, at least one pressure pick-up for pressure detection, at least one pressure control valve for limiting the pressure of the delivery flow, and a proportional valve for the delivery volume, and setting pressure of the hydraulic pump unit delivery flow, and the pressure in the first pressure chamber via the tank valve and a collection tank.

13. The method according to claim 10, further comprising setting the OT position of the main piston with the central control unit via a displacement measuring system, wherein the delivery volume of the hydraulic pump unit is reduced before the OT is reached, and a counter pressure is generated by the tank valve.
